(19) United States
(12) Patent Application Publication
(10) Pub. No.: US 2015/0131802 A1
(43) Pub. Date: May 14, 2015

(54) STEREO MICROPHONE

(71) Applicant: Hiroshi Akino, Tokyo (JP)

(72) Inventor: Hiroshi Akino, Tokyo (JP)

(73) Assignee: Kabushiki Kaisha Audio-Technica, Tokyo (JP)

(21) Appl. No.: 14/528,131

(22) Filed: Oct. 30, 2014

(30) Foreign Application Priority Data
Nov. 8, 2013 (JP) 2013-231998
Aug. 11, 2014 (JP) 2014-163557

(51) Int. Cl. H04R 5/027

(52) U.S. Cl. CPC H04R 5/027
USPC 381/26

(57) ABSTRACT

A stereo microphone includes a nondirectional microphone unit and two bidirectional microphone units, the bidirectional microphone units having directional axes disposed on a single plane at predetermined angles to the center axis of the directionality of the stereo microphone, an acoustic terminal of the nondirectional microphone unit being disposed in the vicinity of acoustic terminals of the bidirectional microphone units.

### BACKGROUND OF THE INVENTION

1. Technical Field

The present invention relates to a stereo microphone for stereophonic pickup. Specifically, the present invention relates to a stereo microphone that has a directional axis that does not deviate from the direction of a sound source during pickup of high-frequency sounds and can independently vary the left and right directional angles.

2. Background Art

Stereo microphones are used for pickup of stereophonic sounds. Several different schemes are known for stereo microphones. For example, Japanese Unexamined Patent Application Publication No. 2006-174136 discloses a stereo microphone of an MS scheme in which an S (side) signal is added to or subtracted from an M (mid) signal to acquire L (left) and R (right) signals.

Stereo microphones of an XY scheme are also known. An XY stereo microphone has two unidirectional microphone units. The directional axes of the unidirectional microphone units are formed at predetermined angles to the sound pickup direction. The XY stereo microphone combines the signals from the unidirectional microphone units to acquire a stereo signal. Unidirectionality can be achieved with a microphone unit other than a unidirectional microphone unit. For example, a signal like an output signal from a unidirectional microphone unit can be acquired through a combination of an output signal from a nondirectional (omnidirectional) microphone unit and an output signal from a bidirectional microphone unit. An output signal acquired through such a combination has unidirectionality similar to that of an output signal from a unidirectional microphone unit.

A nondirectional condenser microphone unit has a stable and enhanced frequency response to low to high frequency bands. A bidirectional ribbon microphone unit has enhanced directionality. A unidirectional microphone unit combining the nondirectional microphone unit and the bidirectional microphone unit also has enhanced frequency response and directionality.

Such a unidirectional microphone unit combining a nondirectional microphone unit and a bidirectional microphone unit can be used in an XY stereo microphone to achieve enhanced frequency response and directionality. The combinations of the nondirectional microphone unit and the bidirectional microphone unit must be disposed on both the left and right.

### SUMMARY OF THE INVENTION

Unfortunately, XY stereo microphones having unidirectional microphone units consisting of the combinations described above have the following issues. In the unidirectional microphone unit consisting of a combination described above, the position of the acoustic terminal of the nondirectional microphone unit and the position of the acoustic terminal of the bidirectional microphone unit differ from each other. The acoustic terminals at different sites pick up different sounds due to the frequency dependencies of the directional axes. The left and right directional axes of such an XY stereo microphone deviate from the direction of the sound source (pickup direction). In particular, short-wavelength, high-frequency acoustic waves have sharp directionality and are often misattributed to a sound source other than the actual sound source.

An object of the present invention is to provide a stereo microphone having a directional axis that does not deviate from the direction of a sound source during pickup of high-frequency sound waves.

A stereo microphone includes a nondirectional microphone unit and two bidirectional microphone units, the bidirectional microphone units having directional axes disposed on a single plane at predetermined angles to the directionality axis of the stereo microphone, an acoustic terminal of the nondirectional microphone unit is disposed in the vicinity of acoustic terminals of the bidirectional microphone units.

According to the present invention, a directional axis does not deviate from the direction of a sound source during pickup of high-frequency sound waves.

### BRIEF DESCRIPTION OF DRAWINGS

FIG. 1 is a plan view of a stereo microphone according to an embodiment of the present invention.

FIG. 2 is a side view of the stereo microphone.

FIG. 3 is an external view of an example unidirectional unit of the stereo microphone.

FIG. 4A is a front view of a bidirectional unit of the stereo microphone.

FIG. 4B is a side view of the bidirectional unit of the stereo microphone.

FIG. 4C is a plan view of the bidirectional unit of the stereo microphone.

FIG. 5 is an example circuit diagram of the stereo microphone.

FIG. 6A illustrates an example frequency response of a condenser microphone unit of the stereo microphone.

FIG. 6B illustrates an example frequency response of a ribbon microphone unit of the stereo microphone.

FIG. 6C illustrates an example frequency response of a combination of the microphone units.

FIG. 7A illustrates example directionality of the condenser microphone unit.

FIG. 7B illustrates example directionality of the ribbon microphone unit.

FIG. 7C illustrates example directionality of a combination of the microphone units.

FIG. 8 illustrates example directionality of the stereo microphone.

### DESCRIPTION OF THE PREFERRED EMBODIMENT

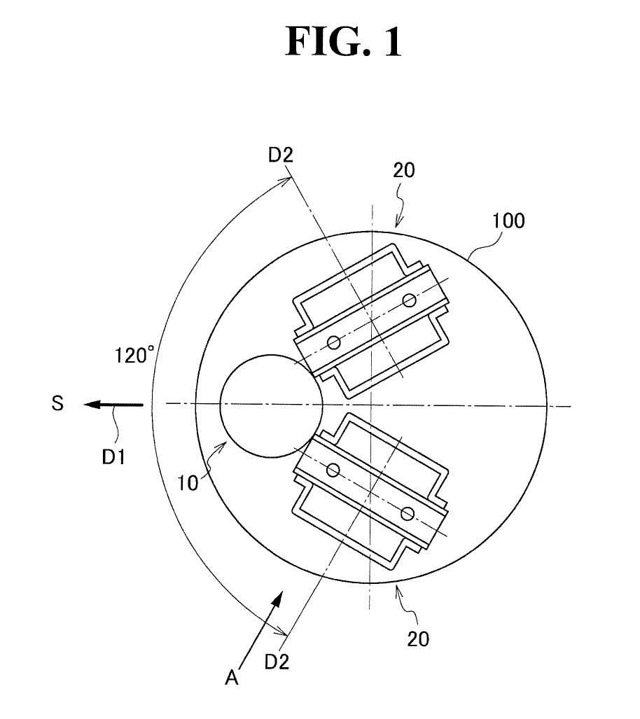

Stereo microphones according to an embodiment of the present invention will now be described with reference to the accompanying drawings. The casing of a stereo microphone 100 is not illustrated in FIG. 1. The stereo microphone 100 includes a condenser microphone unit 10 and two ribbon microphone units 20. The condenser microphone unit 10 has nondirectionality. The ribbon microphone units 20 have bidirectionality.

With reference to FIG. 1, the center axis D1 representing the directionality of the stereo microphone 100 extends in a pickup direction S. The directionality axes D2 of the two ribbon microphone units 20 extend on a single plane and have a predetermined angle to the center axis D1. The condenser microphone unit 10 is disposed within the angle defined by the two directionality axes D2 of the ribbon microphone units 20 on the same plane. The condenser microphone unit 10 is closer to the center axis Dl than the ribbon microphone units 20.

The directionality axes D2 of the ribbon microphone units 20 tilt by 60 degrees to the left and right from the center axis Dl of the directionality of the stereo microphone 100. The two directionality axes D2 define a 120 degree angle. The directionality axes D2 are preferably formed at angles between 45 to 60 degrees to the pickup direction S.

The condenser microphone unit 10 is disposed in the vicinity of the ribbon microphone units 20. Specifically, the condenser microphone unit 10 is disposed on a side of the intersection of axes orthogonal to the directionality axes D2 of the ribbon microphone units 20.

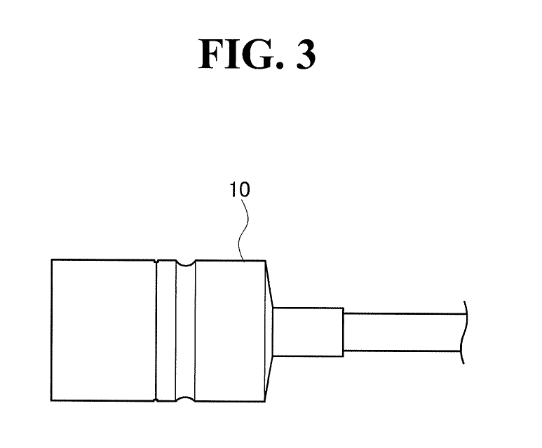

The condenser microphone unit 10 and the ribbon microphone units 20 will now be described. With reference to FIG. 3, the condenser microphone unit 10 has nondirectionality. The acoustic terminal of the condenser microphone unit 10 appears at the left end of the drawing in FIG. 3.

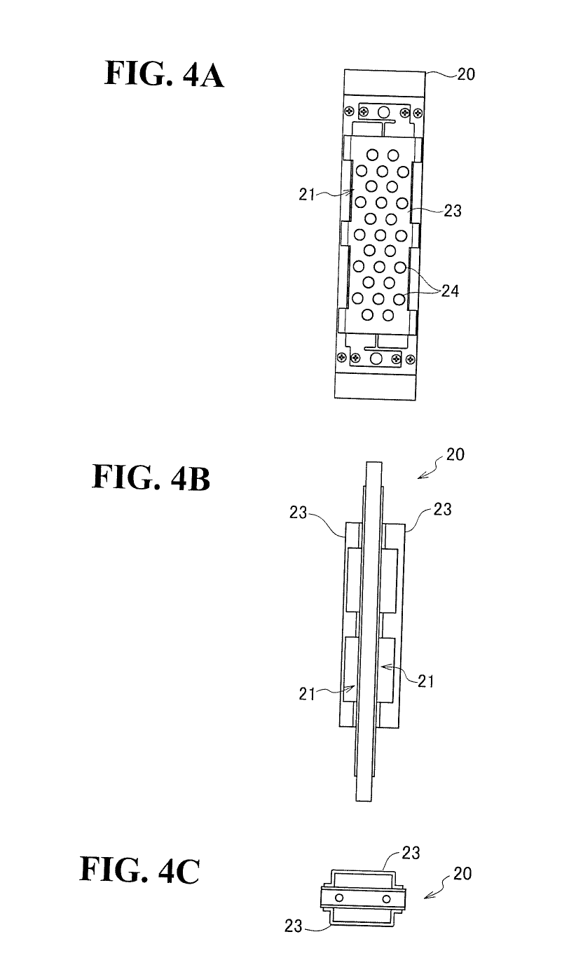

With reference to FIG. 4B, each of the ribbon microphone units 20 has ribbon diaphragms 21 having a predetermined length on both sides of the ribbon microphone unit 20. With reference to FIGS. 4B and 4C, protective plates 23 cover the ribbon diaphragms 21 for protection of the ribbon diaphragms 21. The protective plate 23 has a plurality of holes 24, as illustrated in FIG. 4A. Sound waves traveling through the holes 24 vibrate the ribbon diaphragms 21. Acoustic terminals of the ribbon microphone unit 20 appear along the longitudinal direction of the two ribbon diaphragms 21. That is, in the ribbon microphone unit 20, a first acoustic terminal appears on one of the directions of the vibration of the ribbon diaphragms 21, and a second acoustic terminal appears on the other of the directions.

With reference to FIG. 1, the first acoustic terminal of the ribbon microphone unit 20 faces the center of the stereo microphone 100. The first acoustic terminal is disposed in the central area of the stereo microphone 100 in plan view. The second acoustic terminal faces the exterior of the stereo microphone 100. The second acoustic terminal is disposed in the vicinity of the exterior of the stereo microphone 100 in plan view.

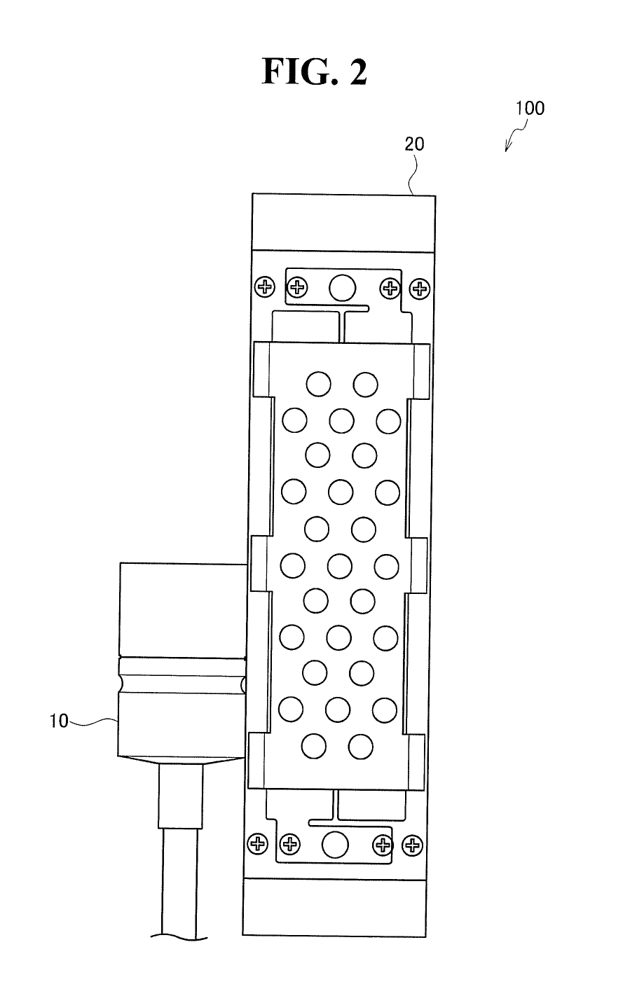

With reference to FIG. 2, the ribbon microphone units 20 and the condenser microphone unit 10 are at fixed relative positions. That is, the position of the condenser microphone unit 10 and the positions of each ribbon microphone unit 20 are fixed relative to each other such that the acoustic terminal of the condenser microphone unit 10 is disposed in the central area of the diaphragms of the ribbon microphone unit 20 along the longitudinal direction.

With reference to FIGS. 1 and 2, the distance between the first acoustic terminals of the ribbon microphone units 20 is small on a horizontal plane orthogonal to the longitudinal direction of the diaphragms of the ribbon microphone units 20. That is, the first acoustic terminals of the two ribbon microphone units 20 in the stereo microphone 100 are disposed close to each other. The second acoustic terminals of the ribbon microphone units 20 are oriented in the different direction to form a predetermined spread angle on the horizontal plane. That is, the second acoustic terminals of the two ribbon microphone units 20 of the stereo microphone 100 are disposed apart from each other.

With reference to FIG. 3, the acoustic terminal of the condenser microphone unit 10 is disposed on a horizontal plane that contains the ribbon microphone unit 20 and is orthogonal to the longitudinal direction of the diaphragms of the ribbon microphone unit 20. That is, the acoustic terminal of the condenser microphone unit 10 is disposed in the vicinity of the first and second acoustic terminals of the ribbon microphone units 20.

The first and second acoustic terminals of the ribbon microphone units 20 are disposed on a single plane containing the directional axes D2. The acoustic terminal of the condenser microphone unit 10 is disposed in the vicinity of the first and second acoustic terminals of the ribbon microphone units 20. The acoustic terminal of the condenser microphone unit 10 and the second acoustic terminals of the ribbon microphone units 20 disposed close to each other pick up the same sounds. The acoustic terminal of the condenser microphone unit 10 and the first and second acoustic terminals of the ribbon microphone units 20 arranged as described above achieve the same directionality as that of a unidirectional microphone having the directional axes D2.

The acoustic terminals according to this embodiment correspond to positions in the air that effectively apply acoustic pressure to the condenser microphone unit 10 and the ribbon microphone units 20. Specifically, an acoustic terminal is the central position in the air that moves simultaneously with the diaphragm in each microphone unit. In other words, an acoustic terminal is the acoustic center of each microphone unit.

In this embodiment, the left and right ribbon microphone units 20 are disposed in the vicinity of the single nondirectional condenser microphone unit 10. Thus, the acoustic terminal of the condenser microphone unit 10 is disposed in the vicinity of the first acoustic terminals of the ribbon microphone units 20. Similarly, the acoustic terminal of the condenser microphone unit 10 is disposed in the vicinity of the second acoustic terminals of the ribbon microphone units 20. The condenser microphone unit 10 and the ribbon microphone units 20 receive sound waves with equivalent effective value of acoustic pressure. The condenser microphone unit 10 and the ribbon microphone units 20 pick up the same sound waves in the directions of the directionality axes D2. The each signal output from the left and right ribbon microphone units 20 is added to the signal output from the condenser microphone unit 10.

For these reasons, a combination of the microphone units according to this embodiment functions as two unidirectional microphones having directionality axes D2, and thus functions as the stereo microphone 100 outputting left and right audio signals.

The two ribbon microphone units 20 are arranged symmetrically about the center axis D1. Thus, the positions of the acoustic terminals of the two ribbon microphone units 20 are also symmetrically about the center axis D1. Consequently, the two unidirectional microphone units have the same directionality through the combination of the ribbon microphone units 20 and the condenser microphone unit 10.

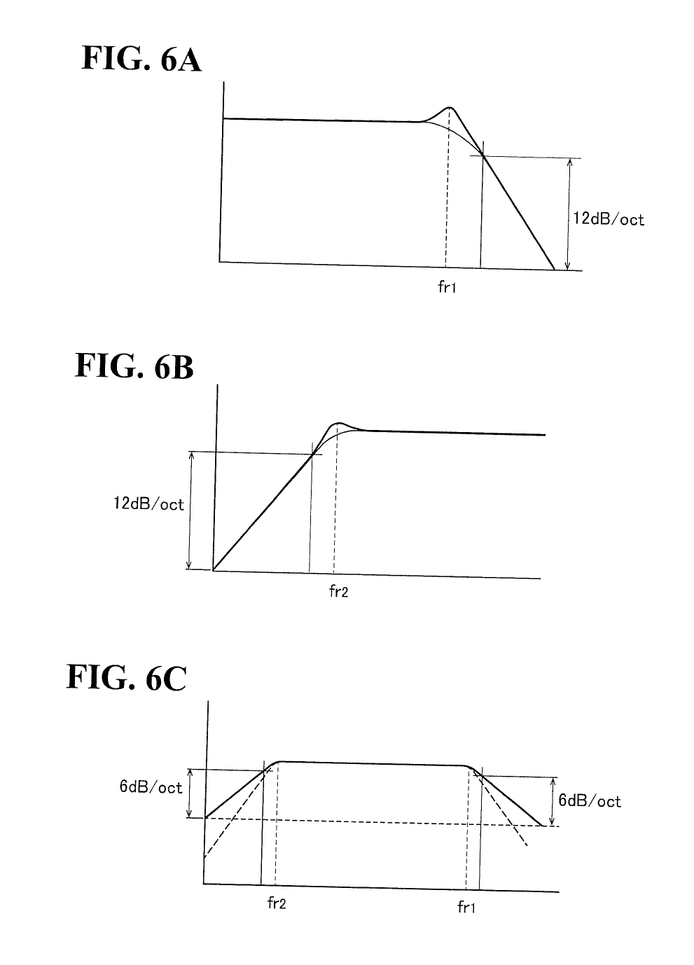

The frequency response of the condenser microphone unit 10, the frequency response of the ribbon microphone units 20, and the frequency response of the stereo microphone 100 consisting of a combination of the condenser microphone unit 10 and ribbon microphone units 20 will now be described. FIG. 6A illustrates an example frequency response of the condenser microphone unit 10. FIG. 6B illustrates an example frequency response of the ribbon microphone units 20. FIG. 6C illustrates an example frequency response of the stereo microphone 100.

The nondirectional condenser microphone unit 10 is of an stiffness-controlled type. With reference to FIG. 6A illustrating the frequency response of the condenser microphone unit 10, the output level for any frequency in a frequency band below a resonance frequency fr1 is substantially constant. In contrast, the output level in a frequency band above the resonance frequency fr1 varies greatly with the frequency. The output level suddenly drops for frequencies higher than the resonance frequency fr1. The drop is approximately equal to −12 dB/oct, which is a decrease by −12 dB per octave.

The bidirectional ribbon microphone units 20 are of a mass-controlled type. With reference to FIG. 6B illustrating the frequency response of the ribbon microphone units 20, the output level for any frequency in a frequency band above a resonance frequency fr2 is substantially constant. In contrast, the output level in a frequency band below the resonance frequency fr2 varies greatly with the frequency. The increase is approximately equal to 12 dB/oct, which is an increase by 12 dB per octave.

The stereo microphone 100 includes a combination of stiffness-controlled and mass-controlled microphone units. The stereo microphone 100 has a frequency response derived from a combination of the opposite frequency responses of the stiffness-controlled and mass-controlled microphone units, as illustrated in FIG. 6C. The stereo microphone 100 has stable frequency characteristics with a substantially constant output level in a wide frequency band ranging from low to high frequencies.

With reference to FIG. 6C, the stereo microphone 100 has a frequency response in which the output level varies in a frequency band below the resonance frequency fr2 and a frequency band above the resonance frequency fr1. This variation, which is approximately 6 dB/oct, is more moderate than the variations in the frequency responses illustrated in FIGS. 6A and 6B. That is, the variation in the frequency response of the stereo microphone 100 is approximately half of that in each of the frequency responses of the condenser microphone unit 10 and the ribbon microphone units 20. The stereo microphone 100 has a frequency response that is more stable than the frequency responses of stereo microphones of other schemes. Thus, the stereo microphone 100 can pick up high-frequency sound waves without deviation of the directional axis from the direction of the sound source.

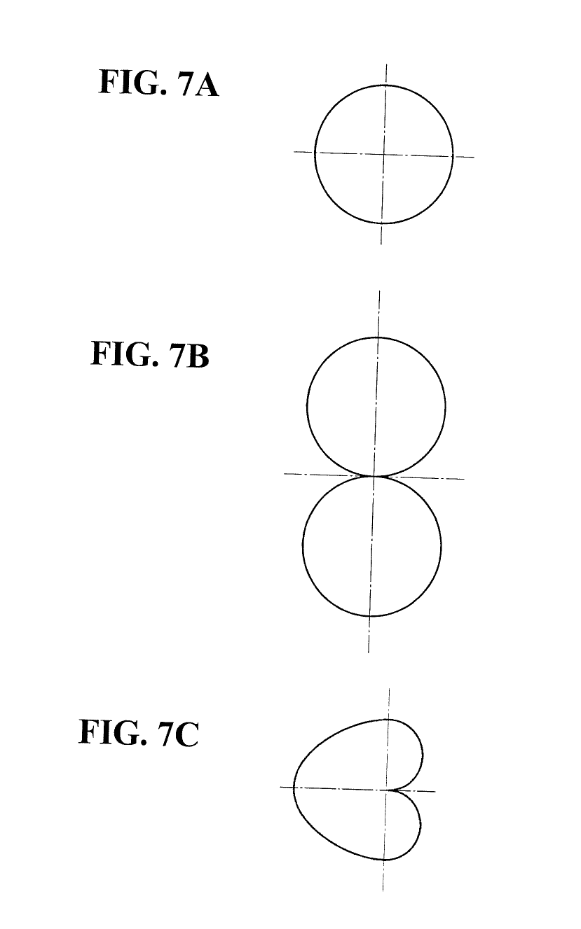

The directionality of the stereo microphone 100 will now be described. FIG. 7A illustrates an example directionality of the condenser microphone unit 10. FIG. 7B illustrates an example directionality of each ribbon microphone unit 20. FIG. 7C illustrates an example directionality of a combination of the condenser microphone unit 10 and the ribbon microphone unit 20.

With reference to FIG. 7A, the condenser microphone unit 10 has nondirectionality and picks up sounds in all directions. With reference to FIG. 7B, each ribbon microphone unit 20, which has bidirectionality, can pick up sounds with high sensitivity in the direction of the sound source and the direction opposite to the sound source. FIG. 7C illustrates unidirectionality of a combination of nondirectionality and bidirectionality, in which sound is picked up with high sensitivity in the direction of the sound source. That is, a microphone unit consisting of a combination of the condenser microphone unit 10 and the ribbon microphone unit 20 has unidirectionality.

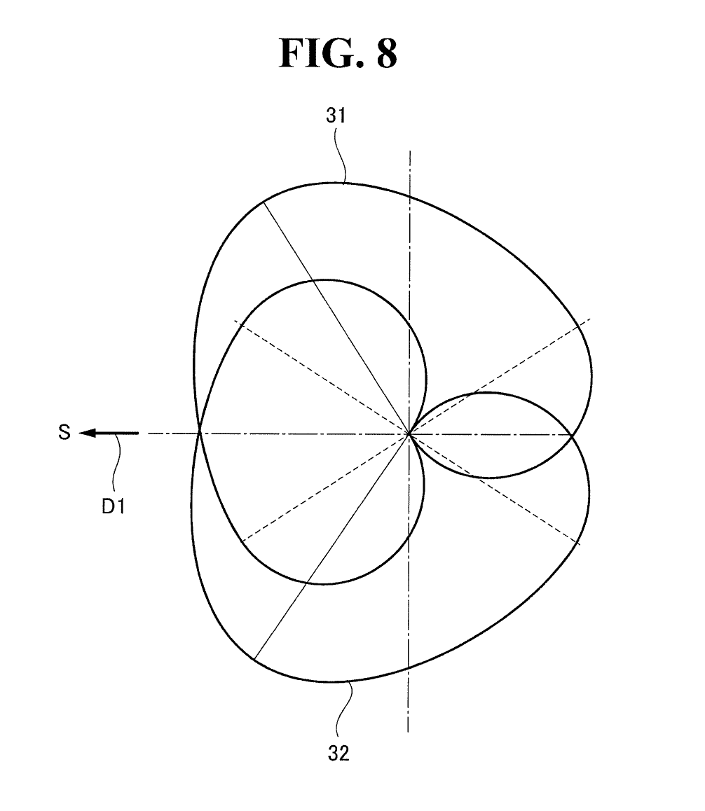

With reference to FIG. 8, the directionality of the stereo microphone 100 is obtained through a combination of the unidirectionality of a right channel 31 and the unidirectionality of a left channel 32. The right channel 31 is obtained through a combination of the directionality of the condenser microphone unit 10 and the directionality of one of the ribbon microphone units 20. The left channel 32 is obtained through a combination of the directionality of the condenser microphone unit 10 and the directionality of the other ribbon microphone unit 20.

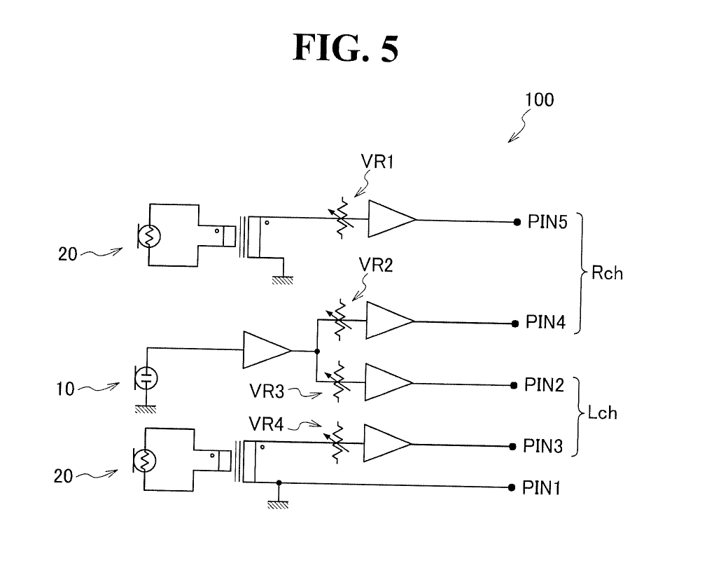

With reference to FIG. 5, the output of the condenser microphone unit 10 branches into two systems. The output terminals of the branching outputs of the condenser microphone unit 10 are combined with the output terminals of the respective ribbon microphone units 20 to form a right channel (Rch) and a left channel (Lch). The branching outputs of the condenser microphone unit 10 are connected to variable resistors VR2 and VR3. The variable resistors VR2 and VR3 vary the level of the output signals from the condenser microphone unit 10, and the branching outputs can be controlled independently. The outputs of the two ribbon microphone units 20 are connected to variable resistors VR1 and VR4. The variable resistors VR1 and VR4 can independently control the output signals of the ribbon microphone units 20.

The output signals from one output terminal (PIN4) of the condenser microphone unit 10 and one output terminal (PIN5) of the ribbon microphone units 20 are combined and output from the Rch of the stereo microphone 100. The output signals from the other output terminal (PIN2) of the condenser microphone unit 10 and the other output terminal (PIN3) of the ribbon microphone unit 20 are combined and output from the Lch of the stereo microphone 100.

The stereo microphone 100 can divide the signal from a single condenser microphone unit 10 into Rch and Lch output signals. The signal levels can be independently varied. Thus, the directionality of the stereo microphone 100 can be varied by varying the output level of the condenser microphone unit 10.

Specifically, an increase in the level of the signal from the condenser microphone unit 10 relative to the level of the signals from the ribbon microphone units 20 increases the nondirectional component of the signal from the stereo microphone 100. As a result, the directionality of the stereo microphone 100 has a subcardioid pattern.

In contrast, a decrease in the level of the signal from the condenser microphone unit 10 relative to the level of the signals from the ribbon microphone units 20 decreases the nondirectional component of the signal from the stereo microphone 100. As a result, the directionality of the stereo microphone 100 has a hypercardioid pattern.

A variation in the level of the signals from the ribbon microphone units 20 varies the direction of the center axis D1 of the stereo microphone 100. That is, the intensity of the sound collected through the left and right channels varies, and thus the left and right balance of the picked up sounds can be controlled by the stereo microphone 100.

The stereo microphone 100 is an XY stereo microphone having enhanced frequency response and directionality. That is, the bidirectional ribbon microphone units 20 detect particle velocity components on the left and right of the pickup direction on a horizontal plane. The detected particle velocity components are added to the audio signal from the nondirectional condenser microphone unit 10. Consequently, the stereo microphone 100, which includes only one nondirectional microphone unit, achieves stereophonic pickup comparable to that of a combination of unidirectional microphone units.

In the stereo microphone 100, the acoustic terminals of the ribbon microphone units 20 can be disposed in the vicinity of the acoustic terminal of the condenser microphone unit 10. As a result, the stereo microphone 100 can pick up high-frequency sound waves without deviation of the directional axes from the direction of the sound source.

The stereo microphone 100 can vary the combined ratio of a nondirectional component and a bidirectional component for the left and right channels, and thus the overall directionality can be independently varied for the left and right channels. The stereo microphone 100 includes three microphone units, of which the output levels can be independently varied.

The directional angle defined by the two ribbon microphone units 20 should not be limited to 45 to 60 degrees and may be varied without departing from the scope of the present invention.

What is claimed is:

1. A stereo microphone comprising;
a nondirectional microphone unit; and
two bidirectional microphone units,
the bidirectional microphone units having directional axes disposed on a single plane at predetermined angles to the center axis of the directionality of the stereo microphone,
an acoustic terminal of the nondirectional microphone unit is disposed in the vicinity of acoustic terminals of the bidirectional microphone units.

2. The stereo microphone according to claim 1, wherein,
the bidirectional microphone units comprise ribbon microphone units, and
the acoustic terminal of the nondirectional microphone unit is disposed at a middle area in the longitudinal direction of diaphragms of the ribbon microphone units.

3. The stereo microphone according to claim 1, wherein,
the output level of the nondirectional microphone unit is variable, and
the directionality varies in accordance with the output level of the nondirectional microphone unit.

4. The stereo microphone according to claim 1, wherein the directional axes of the bidirectional microphone units are independently variable.

5. The stereo microphone according to claim 1, wherein the nondirectional microphone unit is disposed on a side on which axes orthogonal to the directional axes of the bidirectional microphone units intersect.

6. The stereo microphone according to claim 1, wherein each of the bidirectional microphone units comprises:
a first acoustic terminal; and
a second acoustic terminal,
wherein the first acoustic terminals of the bidirectional microphone units are disposed in the vicinity of each other, and the second acoustic terminals of the bidirectional microphone units are disposed apart from each other.
